(19) United States
(12) Patent Application Publication
(10) Pub. No.: US 2014/0352068 A1
(43) Pub. Date: Dec. 4, 2014

(54) ELECTRIC MOTORIZED BED

(71) Applicant: JIANCHUN XU, JIAXING CITY (CN)

(72) Inventor: JIANCHUN XU, JIAXING CITY (CN)

(73) Assignee: JIAXING SHUFUDE ELECTRIC BED CO., LTD., ZHEJIANG (CN)

(21) Appl. No.: 14/301,024

(22) Filed: Jun. 10, 2014

Related U.S. Application Data
(63) Continuation-in-part of application No. 13/908,168, filed on Jun. 3, 2013.

(30) Foreign Application Priority Data
Jul. 5, 2013 (CN) 201320399032.4
Sep. 10, 2013 (CN) 201320559726.X

(51) Int. Cl. A47C 20/04; A61G 7/018; A61G 7/015

(52) U.S. Cl. CPC A47C 20/041; A61G 7/015; A61G 7/018
USPC 5/616

(57) ABSTRACT

An electric motorized bed has a bedframe, and multiple bed boards. The bedframe includes an upper bedframe and a lower bedframe. The upper bedframe and lower bedframe are connected by a guide rail. Multiple bed boards are connected to each other and one bedboard is connected to the bedframe. The slider motor system has a connecting rod. The slider motor systems two sides are connected to the lower bedframe. The slider motor system has a slider connecting with one of the bed boards using a connecting rod. The slider motor system has a slider that can move between a nonmovable position and a movable position. In the nonmovable position there is another bed board positioned horizontally. In the movable position, another bedboard is positioned to be capable of being raised and lowered. Another bedboard can be positioned at any location between the horizontal position and a vertical moving position.

This application claims priority from and is a Paris Convention Treaty of non-provisional applications: People's Republic of China utility model patent application 201320559726.X entitled Electric Movable Bed, filed Sep. 10, 2013, by inventor Xu, Jianchun; and People's Republic of China utility model patent application 201320399032.4 entitled Electric Movable Bed; filed Jul. 5, 2013 by inventor Xu, Jianchun, the disclosures of which are incorporated herein by reference.

### FIELD OF THE INVENTION

The field of the invention is in the field of adjustable electric beds.

### BACKGROUND

Electric beds are now widely used as rates of obesity and elder care have increased. The bed board of a common electric bed includes multiple boards: a head board, a fixed board that can be a seat board, a leg board, and a foot board. The boards are connected in series by hinges, and are lifted by a motor driving the boards to meet various postural requirements during use.

An upper bed frame and a lower bed frame are movably connected with the upper bed frame arranged below the bed board. The bed board is lifted by a motor installed front and back to meet the requirements for postural change during use. The upper bed frame and the lower bed frame for the common electric bed is an integral type bed frame matching the electric bed in size. The upper bed frame and the lower bed frame are movably connected by a sliding rail and a guide wheel to meet electric bed operational requirements. The integrated frame design is inconvenient for packing and transport and is difficult for handling into a house. As the integrated frame design is limited by a residential lift or stair, it is difficult to move the integral type bed frame. If some electric beds cannot be moved into a house, it greatly limits the available uses of the electric bed.

Nonetheless, the motor used generally is a linear actuator, one of which is hinged with the bed board and the other end of which is directly hinged with a bed frame. As the linear actuator limits motion to only linear motion, any uneven pressure applied to the linear actuator by the bed board acts on the hinge joint connected with the bed frame in the lengthwise direction of the linear actuator. More particularly, the hinge joint bears very large pressure when the bed board is lifted by the motor. Therefore, the hinge joint is easily damaged or worn prematurely due to fatigue damage. At the same time, the traditional structure needs a single force bearing point on the bed board which necessitates higher bed frame production costs.

### SUMMARY OF THE INVENTION

The invention provides a new electric bed, which eliminates defects in the traditional electric bed such as fatigue damage of the hinge joint, and increased pressure on the bearing unit. The present invention contributes to pressure dispersion, increases service life, and improves the application performance of the electric bed.

The electric bed has a bed frame, multiple boards and an a motor structure. The bed frame includes a lower bed frame and an upper bed frame, and the upper bed frame and the lower bed frame are connected by a guide rail connecting structure. The multiple boards are hinged, and at least one board is fixed onto the upper bed frame.

Among those, the motor structure includes a slider motor system and a connecting rod, and two ends of the slider motor system are fixed onto the lower bed frame. The slider in the slider motor system is hinged with first board of the multiple boards by the connecting rod. The slider in the slider motor system can move back-and-forth between an immobile position and a mobile position. In the immobile position there is the first board in the horizontal position. In the mobile position there is the first in the raising position. The first board can be positioned between the horizontal position and the raising position.

Optionally, the sliding motor system has a position sensor that can sense the slider position when the slider is outside of the immobile position and in the mobile position. The slider can be limited to protect the slider motor from being damaged.

Optionally, the slider motor system further includes a controller and a control circuit, and the controller can control the movement of the slider using the control circuit.

Optionally, the controller is a remote control.

The dismountable electric bed frame according to the invention includes the upper bed frame and the lower bed frame. The upper bed frame and the lower bed frame are movably connected with a guide rail and a guide wheel. The upper bed frame includes an upper front bed frame and an upper rear bed frame, the upper front bed frame and the upper rear bed frame are horizontally arranged in adjacent positions and connected by a connecting component such as a bolt, the lower bed frame includes a lower front bed frame and a lower rear bed frame, and the lower front bed frame and the lower rear bed frame are horizontally arranged in adjacent positions and connected by a connecting component such as a bolt.

Optionally, the upper bed frame further includes a driving motor, a drive rod, a connecting rod and six guide wheels. The six guide wheels are separately arranged on two sides of the upper front bed frame and the upper rear bed frame. The connecting rod is arranged in the middle of the upper rear bed frame in an axial direction. The driving motor is arranged on the connecting rod, and two ends of the driving rod are respectively hinged with the bed board and the bed board driving motor.

Optionally, the lower bed frame further includes a head board driving motor, a drive rod and a connecting rod. The guide rail is respectively arranged on opposite inner sides of the lower front bed frame and the lower rear bed frame of the lower bed frame. The guide wheels on two sides of the upper front bed frame of the upper bed frame are located in the guide rail on the opposite inner side of the lower front bed frame of the lower bed frame. The guide wheels on the upper rear bed frame of the upper bed frame are located in the guide rail on the opposite inner side of the lower rear bed frame of the lower bed frame. The connecting rod is arranged in the middle of the lower front bed frame in axial direction. The head board driving motor is arranged on the connecting rod, and two ends of the second drive rod are respectively hinged with the head board and the head board driving motor.

Furthermore, the first driving motor and the second driving motor are a linear slider motors and can respectively slide a first bracket and a second bracket to actuate a first connecting rod and a second connecting rod.

The dismountable electric bed frame includes the upper bed frame and the lower bed frame. The upper bed frame and the lower bed frame are movably connected by the guide rail and the guide wheel. The upper bed frame includes the upper front bed frame and the upper rear bed frame.

The upper front bed frame and the upper rear bed frame are horizontally arranged in adjacent positions and connected by the bolt connection. The lower bed frame includes the lower front bed frame and the lower rear bed frame. The lower front bed frame and the lower rear bed frame are horizontally arranged in adjacent positions and connected by the bolt connection. The electric bed frame seeks to eliminate the defects of the traditional electric bed such as difficulties in packing, transport and handling. The improved electric bed frame seeks to save packing and transport costs, reduce labor requirements, facilitate handling of the electric bed into a house, and improve the application performance of the electric bed.

Optionally, the slider motor system further includes a wireless receiver which can receive the signal from the remote control and controls the movement of the slider by the control circuit.

Optionally, the motor structure includes a second slider motor system and a second connecting rod and two ends of the second slider motor system are fixed onto the upper bed frame. The slider in second slider motor system is hinged with the second board of the multiple boards by the second connecting rod. The slider in the second slider motor system can move back-and-forth between an immobile position and a mobile position. In the immobile position there is the second board in the horizontal position. In the mobile position there is the second board in the raising position. The second board can be positioned in any position between the horizontal position and the raising position.

The linear actuator linear actuator commonly used in traditional bed frames is replaced with the slider motor, and two ends of the slider motor are fixed onto the lower bed frame so that all pressure previously applied at the hinge joint between the linear actuator and the bed frame can be dispersed at two fixing points to greatly reduce the pressure applied on all parts. The reduction of pressure seeks to prolong the service life of all parts and improve the performance of the electric bed. Additionally, the strength requirement of materials for many parts can be lowered due to the pressure reduction so that materials with lower strength and cost can be selected to manufacture the relevant parts.

### BRIEF SUMMARY OF THE CLAIMS

An electric motorized bed has a bedframe including an upper bedframe and a lower bedframe. The upper bed frame is slidingly mounted to the lower bedframe at guide rails formed on the lower bedframe. Bed boards include a back board, which is hinged to a seat board, which is hinged to a thigh board, which is hinged to a calf board. The back board is pivotally connected to the bedframe. A first slider motor system has a first motor connected to a first slider that is pivotally connected to a lower end of a first connecting rod and has a first slider mounted on a first link. The first link is connected to the bedframe. An upper end of a first connecting rod is connected to a back board. A second slider motor system has a second motor connected to a second slider that is pivotally connected to a lower end of a second connecting rod and has a second slider mounted on a second link. The second link is connected to the upper frame. An upper end of a second connecting rod is connected to either the thigh board or the calf board.

Operation of the first slider motor system and the second slider motor system allows positioning at any location between a horizontal position and a raised position. The seat board is rigidly connected to the upper frame. The first link is connected to the upper frame. The first motor and the second motor are linear slider motors. The upper frame separates into an upper front frame and an upper rear frame that both connect to the seat board at an upper front frame bolt connector member and at an upper rear frame bolt connector member. The lower frame separates into a lower front frame and a lower rear frame having a bolt connection. The lower frame further includes a lower front frame, wherein the first link is mounted to the lower front frame. The upper frame further includes an upper rear frame, wherein the second link is mounted to the upper rear frame. The seat board is rigidly connected to the upper frame, wherein the first link is connected to the upper frame, and wherein the first motor and the second motor are linear slider motors. A wireless receiver can receive a signal transmitted from a remote control, and slider motion is controlled by a control circuit.

### BRIEF DESCRIPTION OF THE DRAWINGS

FIG. 1 is a bottom perspective view of the bed in raised position.

FIG. 2 is a side view of the bed in flat position.

FIG. 3 is a side view of the bed in raised position.

FIG. 4 is a perspective view of the bed in raised position.

FIG. 5 is a schematic diagram of the dismountable electric bed frame according to the invention.

FIG. 6 is a schematic diagram of the upper bed frame of the dismountable electric bed frame.

FIG. 7 is a schematic diagram for the upper front bed frame of the upper bed frame of the dismountable electric bed frame.

FIG. 8 is a schematic diagram for the upper rear bed frame of the upper bed frame of the dismountable electric bed frame.

FIG. 9 is a schematic diagram of the lower bed frame of the dismountable electric bed frame.

FIG. 10 is a schematic diagram for the lower front bed frame of the lower bed frame of the dismountable electric bed frame.

FIG. 11 is a schematic diagram for the lower rear bed frame of the lower bed frame of the dismountable electric bed frame.

The following callout list of elements can be a useful guide in referencing the elements of the drawings.
1 Electric Bed
2 Motor Structure
3 First Slider Motor System
3′ Second Slider Motor System
4 First Connecting Rod
4′ Second Connecting Rod
5 First Slider
5′ Second Slider
11 Upper Bed Frame
12 Lower Bed Frame
16 Guide Wheel
17 Guide Rails
101 Metal Upper Frame
102 Metal Lower Frame
103 Head Board
104 Leg Board
105 Calf Board
106 Seat Board
107 Thigh Board
111 Upper Front Frame
112 Upper Rear Frame
113 Leg Board Moving Motor
114 Second Link
115 Second Connecting Rod
116 Guide Wheel
117 Bolt Connector
121 Lower Front Frame
122 Lower Rear Frame
123 First Guide Rail
124 Second Guide Rail
125 Head of Bed Board Moving Motor
126 First Link
127 First Connecting Rod
128 Bolt
131 Wireless Receiver
132 Remote Control
133 Control Circuit
134 Wireless Signal

### DETAILED DESCRIPTION OF THE PREFERRED EMBODIMENT

As seen in the figures, several boards have hinge connection to the frame. The boards support the mattress and include the head board which is also called the back board because the backboard supports the back and head and the headboard supports the head and back. A fixed board is sometimes called the seat board as a user sits on the seat board. A thigh board then supports the user's thighs and a leg board or calf board supports the user's legs and feet. The leg board is also called a foot board because the leg board supports the feet. The present invention has the back board also called the headboard attached to the lower frame in a hinged connection at a backboard connection rod. The back board, seat board, thigh board, and calf board are also mounted to and supported by the upper frame 101. The upper frame is supported by the lower frame, and the lower frame rests on the ground. The upper frame has wheels that roll on the first guide rail 123 and the second guide rail 124 of the lower frame.

A key feature of this invention is that a linear motor pushes an arm to raise the footboard, where the lower end of the arm is pivotally mounted to a pivot and where the pivot is mounted on a slider that is pushed by the linear motor. The lower end of the foot board arm slides and rotates at the same time. The linear motor is connected to the frame.

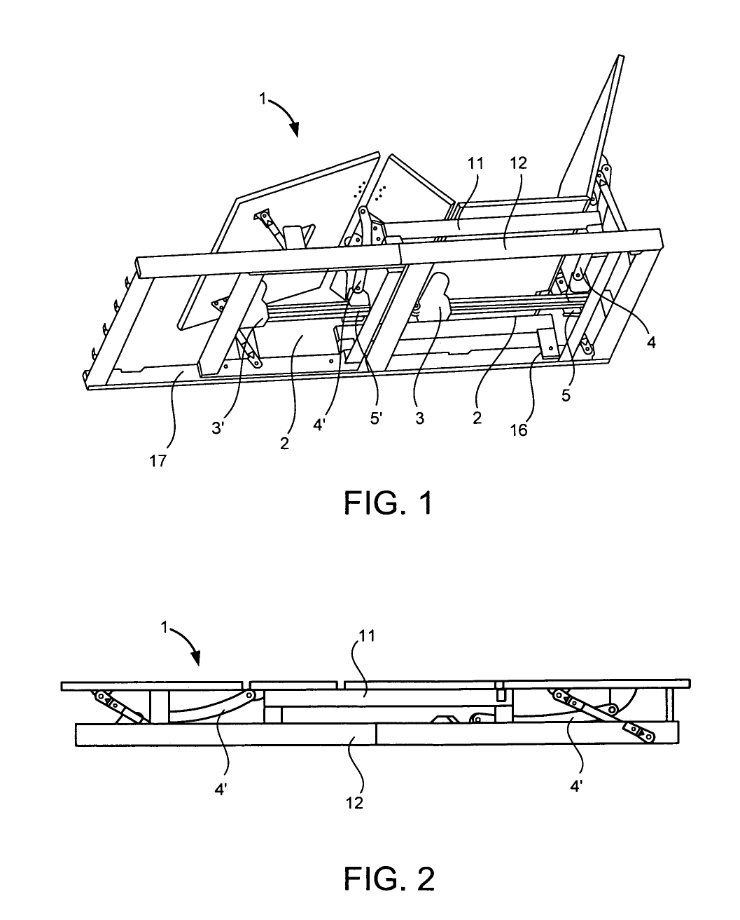

As shown FIGS. 1 and 4, the electric bed 1 includes the bed frame, the multiple hinged support boards and the motor structure 2. The bed frame includes the upper bed frame 11 and the lower bed frame 12. The upper bed frame 11 has a guide wheel 16, and a guide rail 17 for accommodating and guiding the guide wheel 16 which is installed onto the lower bed frame 12. The guide wheel 16 forms a guide rail connecting structure with the guide rail 17. The upper bed frame 11 and the lower bed frame 12 are connected by a guide rail connecting structure. The upper bed frame 11 can make translational motion relative to the lower bed frame 12. At least one board is fixed onto the upper bed frame 11.

Optionally, the upper bed frame 11 can be equipped with the slider. A sliding chute may guide the slider that is arranged onto the lower bed frame 12. The slider could form a sliding connection structure with the sliding chute. The upper bed frame 11 and the lower bed frame 12 can be connected with the sliding connection structure, and the upper bed frame 11 can make translational motion relative to the lower bed frame 12.

As shown in FIG. 1, in the embedment of the electric bed according to the invention, the motor structure 2 includes the slider motor system 3 and the connecting rod 4. Two ends of the slider motor system 3 are fixed onto the lower bed frame 12. The slider 5 in the slider motor system 3 is hinged with the first board of the multiple boards using the connecting rod 4. The slider 5 in the slider motor system 3 can move back-and-forth between an immobile position and a mobile position. Selectively, the slider can be driven by the motor system to move from the immobile position to the mobile position, and return to the immobile position manually or by a reset device.

The screw in the slider motor system 3 is connected with the motor by a coupler. The driving screw of the motor rotates to drive the slider 5 installed on the screw to move. Then, the connecting rod 4 drives the bed board to raise or fall by the linkage of the slider 5. The motor stops when the bed board raises or falls to the designated position. The motor rotates in reverse during recovery to previous position.

During the movement of the slider 5, the pressure applied to the connecting rod 4 by the bed board is dispersed to two ends of the screw. As shown in FIG. 2, when the slider 5 is in the immobile position, the second board can be in the horizontal position.

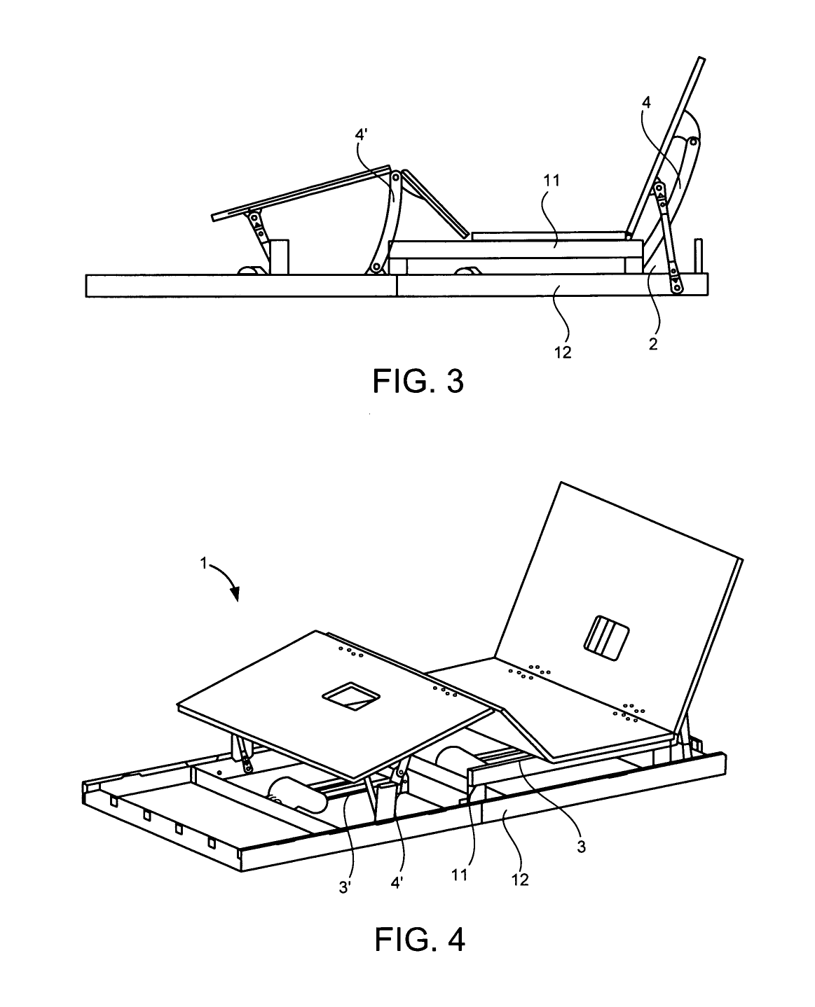

As shown in FIG. 3, when the slider 5 is in the mobile position, the second board can be in the raising or raised position. The second board can be positioned in any position between the horizontal position and the raising position. The slider 5 stops in any position between the horizontal position and the raising position. The second board is fixed in current position by the support of the connecting rod 4 to complete a user-defined adjustable angle and satisfy various demands of the user.

Optionally, a supporting bracket may be added on the lower bed frame fixed on two ends of the slider motor system 3.

In one embodiment, two ends of the screw in the slider motor system 3 are fixed onto the lower bed frame 12, for example, by a welding or a bolted connection, the motor is connected with the slider 5, and the motor directly drives the slider 5 to move on the screw.

In one embodiment, the slider motor system 3 has the position sensor that can sense the position of the slider 5 when the slider motor drives the bed board to rise. The position sensor can sense whether the slider 5 arrives in the mobile position. A signal is given to stop the slider motor to avoid motor overload while sensing the slider 5 arrives in the mobile position.

In one embodiment, the slider motor system 3 further includes the controller and the control circuit. The controller controls the operation of the slider motor by the control circuit. For example, when the user arises the bed board, the controller may be used to operate the slider motor. The motor drives the slider 5 to move, and the connecting rod 4 hinged with the bed board is driven to move by the slider 5 so that the bed board goes to the raising position. The bed board may be folded at a user-defined folding angle by the controller and the control circuit.

In another embodiment, the controller is a remote control. For example, the user may transmit the control signal 134 by an infrared remote control, a Bluetooth remote control, or an application program preset in a communication device. Additionally, the slider motor system 3 further includes the wireless receiver 131 that can receive the signal transmitted from the remote control 132, and the slider 5 is controlled to move by the control circuit 133.

Additionally, the motor structure 2 further includes the second slider motor system 3′ and the second connecting rod 4′. Two ends of the second slider motor system 3′ are fixed onto the upper bed frame 11. The slider in the second slider motor system 3′ is hinged with the second board of the multiple board linkage by the second connecting rod 4′.

The second board and the first board can be positioned on two sides of at least one board on the upper bed frame 11. The slider 5′ in the second slider motor system 3′ can move back-and-forth between an immobile position and a mobile position, and the second board can be positioned in any position between the horizontal position and the raising position.

The second board can be in the horizontal position in the immobile position, and the second board can be in the raising position in the mobile position. The second board therefore has two modes.

Additionally, the slider motor or the linear actuator, or the combination of the slider motor and linear actuator may be respectively arranged in the upper frame and the lower frame of the electric bed 1. The motor structure 2 may be set for the multiple boards according to user requirements. At least one of the multiple boards may be folded by the motor and the motor structure 2 to meet a prone position requirement.

Additionally, the types of connecting rods may very, for example single or multiple connecting rods may be used for the electric beds with various sizes and the bed types. The connecting rod may be also straight or bent, and may be installed in any variety of positions on the bed frame. The operating principle of the connecting rod is that the connecting rod is driven by the slider motor to drive the bed board to a corresponding position so that raising and falling of the bed board is achieved. Optionally, the slider motor system 3 may be also replaced with a linear motor.

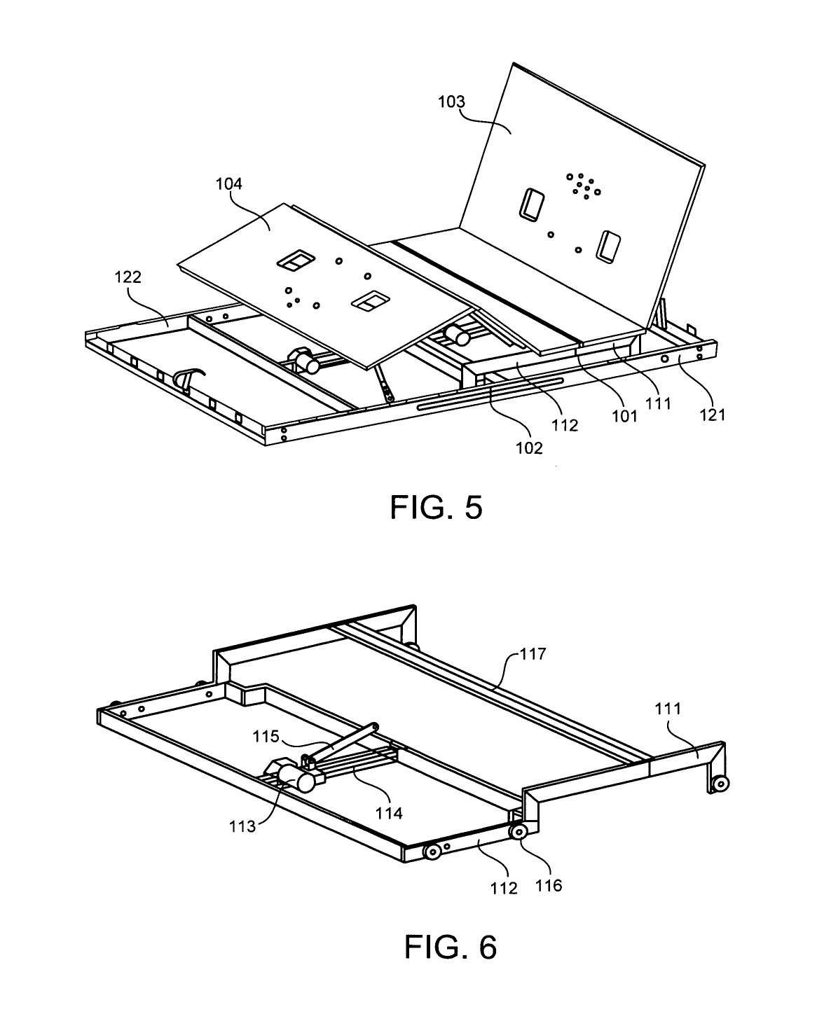

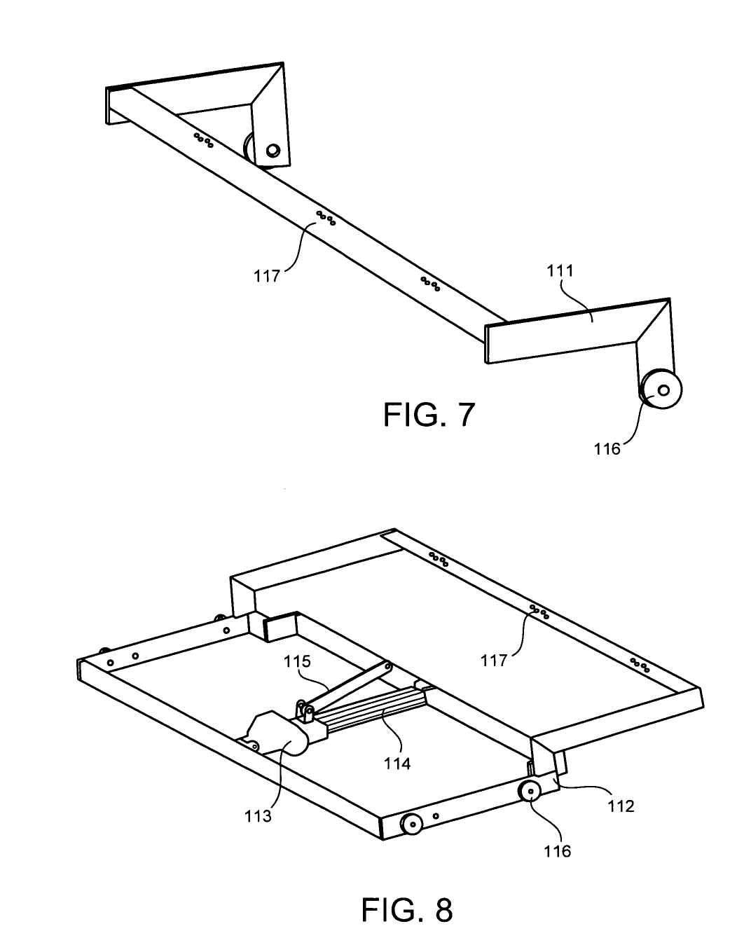

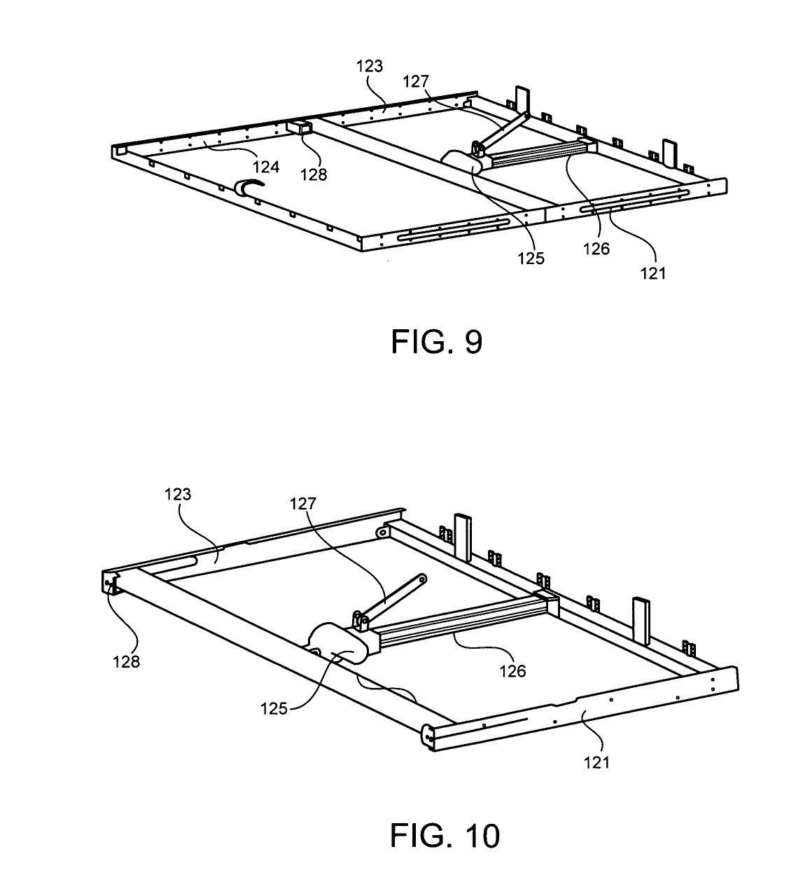

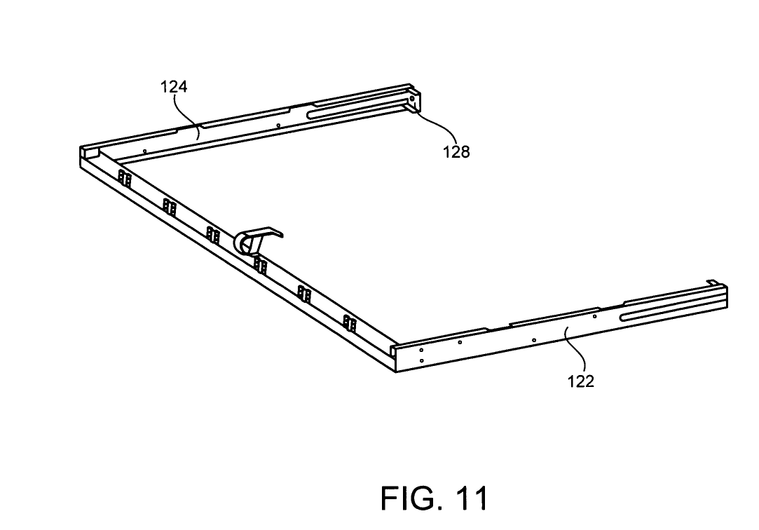

As shown in FIGS. 5-11, the dismountable electric bed frame according to the invention includes the metal upper bed frame 101 and the metal lower bed frame 102. The metal upper bed frame 101 and the metal lower bed frame 102 are connected by the guide rail and the guide wheel. The upper bed frame 101 includes the upper front bed frame 111 and the upper rear bed frame 112. The upper front bed frame 111 and the upper rear bed frame 112 are horizontally arranged in adjacent positions and connected with the bolt 117. The metal lower bed frame 102 includes the lower front bed frame 121 and the lower rear bed frame 122. The lower front bed frame 121 and the lower rear bed frame 122 are horizontally arranged in adjacent positions and connected with a bolt 128.

Furthermore, the upper frame further includes the leg board driving motor 113, the second connecting rod 115, the second link 114 and six guide wheels 116. The six guide wheels 116 are separately arranged on two sides of the upper front bed frame 111. The upper rear bed frame 112, has a second link 114 arranged in the middle of the upper rear bed frame 112 in an axial direction. The leg board driving motor 113 is arranged on the second link 114. The two ends of the second connecting rod 115 are respectively hinged with the leg board 104 and the leg board driving motor 113. The calf bed board supports the calf of the user.

Furthermore, the lower frame further includes the head board driving motor 125, the first connecting rod 4, 127 and the first link 126. The headboard driving motor 125 has a track that is called the first link 126. The first link 126 connects between horizontal members of the lower front frame 121. The first link 126 is formed as a sliding rail and can be rigidly connected or linked across a span of the lower front frame 121 such as by a hinge. A first slider 5 can be formed as a first slider bracket is mounted on the first link 126 so that the first slider bracket slides along the length of the first link 126. The first slider bracket is connected to the first connecting rod 127. The lower end of the first connecting rod 127 is in hinged connection to the first slider bracket. The first connecting rod 127 rotates from a more horizontal position to a more vertical position. As the headboard driving motor 125 pushes the lower end of the first connecting rod 127, the first connecting rod 127 rotates and raises the headboard for the user.

The first guide rail 123 and second guide rail 124 are respectively arranged in the opposite inner side of the lower front bed frame 121 and the lower rear bed frame 122 of the lower bed frame 102. The guide wheels 116 on two sides of the upper front bed frame 111 of the upper bed frame are located in the guide rail 23 on the opposite inner side of the lower front bed frame 121 of the lower bed frame. The guide wheels 116 on two sides of the upper rear bed frame 112 of the upper bed frame are located in the guide rail 124 on the opposite inner side of the lower rear bed frame 122 of the lower bed frame. The first link 126 is arranged in the middle of the lower front bed frame 121 in axial direction. The head board driving motor 125 is arranged on the first link 126. The two ends of the first connecting rod 4, 127 are hinged respectively with the head board 103 and the head board driving motor 125. The headboard 103 also supports the back and can be called a back board.

Furthermore, the leg board driving motor 113 and the head board driving motor 125 are slider motors and can slide respectively along the second link 114 and the first link 126. The rear bed board driving motor 113 is the second motor. The headboard driving motor 125 is the first motor. The leg board moving motor 113 is mounted on the upper rear frame 112 with the second link 114 spanning a linkage between a span of the upper rear frame 112. The activation of the leg board moving motor 113 raises the leg board by pushing the second connecting rod 115 upward and simultaneously rotating the second connecting rod 115. The lower end of the second connecting rod 115 is in hinged connection to a second slider 5′ that can be formed as a second slider bracket. The second slider bracket is mounted to the second link 114. The second link is formed as a rail capable of receiving in a sliding relationship, the second sliding bracket. The second sliding bracket pushes the second connecting rod 115 from a more horizontal position to a more vertical position when the leg board moving motor 113 is activated.

The electric bed frame respectively divides traditional upper bed frame and lower bed frame into front and rear bed frames. The two bed frames are horizontally arranged in adjacent position and connected by the bolt. The two bed frames can be separated and separately packed, transported and handled. When all parts of the electric bed are transported to the house, they can be conveniently assembled by use of bolt connectors without impacting the overall rigidity of the electric bed frame, thereby ensuring safe reliable operation of the electric bed. When handling is required, the upper bed frame and the lower bed frame may be dismounted into an independent bed frame only by removal of the bolt, thereby greatly improving the application performance of the electric bed.

The rear bed board driving motor and the head board driving motor are respectively arranged in the upper bed frame and the lower bed frame of the electric bed frame, a motor structure may be arranged for multiple boards according to user need. The head board, the fixed board, the leg board and the foot board can be relatively rotated by the rear bed board driving motor and the head board driving motor in combination with the corresponding motor structure according to user need for providing a prone position requirement.

1. An electric motorized bed comprising:
a bedframe including an upper bedframe and a lower bedframe, wherein the upper bed frame is slidingly mounted to the lower bedframe at guide rails formed on the lower bedframe;
bed boards including a back board, which is hinged to a seat board, which is hinged to a thigh board, which is hinged to a calf board, wherein the back board is pivotally connected to the bedframe;
a first slider motor system having a first motor connected to a first slider that is pivotally connected to a lower end of a first connecting rod and having a first slider mounted on a first link, wherein the first link is connected to the bedframe;
an upper end of a first connecting rod that is connected to a back board;
a second slider motor system having a second motor connected to a second slider that is pivotally connected to a lower end of a second connecting rod and having a second slider mounted on a second link, wherein the second link is connected to the upper frame;
an upper end of a second connecting rod that is connected to either the thigh board or the calf board; and
wherein operation of the first slider motor system and the second slider motor system allows positioning at any location between a horizontal position and a raised position.

2. The electric motorized bed of claim 1, wherein the seat board is rigidly connected to the upper frame.

3. The electric motorized bed of claim 1, wherein the first link is connected to the upper frame.

4. The electric motorized bed of claim 1, wherein the first motor and the second motor are linear slider motors.

5. The electric motorized bed of claim 1, wherein the upper frame separates into an upper front frame and an upper rear frame that both connect to the seat board at an upper front frame bolt connector member and at an upper rear frame bolt connector member.

6. The electric motorized bed of claim 1, wherein the lower frame separates into a lower front frame and a lower rear frame having a bolt connection.

7. The electric motorized bed of claim 1, wherein the lower frame further includes a lower front frame, wherein the first link is mounted to the lower front frame.

8. The electric motorized bed of claim 1, wherein the upper frame further includes an upper rear frame, wherein the second link is mounted to the upper rear frame.

9. The electric motorized bed of claim 1, wherein the seat board is rigidly connected to the upper frame, wherein the first link is connected to the upper frame, and wherein the first motor and the second motor are linear slider motors.

10. The electric motorized bed of claim 9, wherein the upper frame separates into an upper front frame and an upper rear frame that both connect to the seat board at an upper front frame bolt connector member and at an upper rear frame bolt connector member.

11. The electric motorized bed of claim 9, wherein the lower frame separates into a lower front frame and a lower rear frame having a bolt connection.

12. The electric motorized bed of claim 9, wherein the lower frame further includes a lower front frame, wherein the first link is mounted to the lower front frame.

13. The electric motorized bed of claim 9, wherein the upper frame further includes an upper rear frame, wherein the second link is mounted to the upper rear frame.

14. The electric motorized bed of claim 1, further comprising a wireless receiver that can receive a signal transmitted from a remote control, and wherein slider motion is controlled by a control circuit.

15. The electric motorized bed of claim 14, wherein the upper frame separates into an upper front frame and an upper rear frame that both connect to the seat board at an upper front frame bolt connector member and at an upper rear frame bolt connector member.

16. The electric motorized bed of claim 14, wherein the lower frame separates into a lower front frame and a lower rear frame having a bolt connection.

17. The electric motorized bed of claim 14, wherein the lower frame further includes a lower front frame, wherein the first link is mounted to the lower front frame.

18. The electric motorized bed of claim 14, wherein the upper frame further includes an upper rear frame, wherein the second link is mounted to the upper rear frame.
